(19) United States
(12) Patent Application Publication
(10) Pub. No.: US 2006/0288688 A1
(43) Pub. Date: Dec. 28, 2006

(54) Turbofan core thrust spoiler

(76) Inventor: Jean-Pierre Lair, San Antonio, TX (US)

Correspondence Address: FRANCIS L CONTE, 6 PURITAN AVENUE, SWAMPSCOTT, MA, 01907, US

(21) Appl. No.: 11/455,393

(22) Filed: Jun. 19, 2006

Related U.S. Application Data
(60) Provisional application No. 60/692,714, filed on Jun. 22, 2005.

(51) Int. Cl. F02K 1/64

(52) U.S. Cl. 60/226.2

(57) ABSTRACT

A turbofan engine includes a fan driven by a core engine. A surrounding fan nacelle includes a thrust reverser and fan nozzle disposed aft therefrom. A core cowl surrounds the core engine and includes a core nozzle extending aft therefrom. A row of poppet valves extends through the core cowl between the core nozzle and fan nozzle for selectively spoiling thrust from the core nozzle when the reverser is deployed.

This application claims the benefit of U.S. Provisional Application 60/692714, filed Jun. 22, 2005.

### BACKGROUND OF THE INVENTION

The present invention relates generally to aircraft engines, and, more specifically, to thrust reversers therein.

Modern commercial aircraft are typically powered by a turbofan gas turbine engine in which a fan is driven by a core engine. The core engine includes in serial flow communication a fan, multistage axial compressor, combustor, and high pressure turbine.

Air is pressurized in the compressor and mixed with fuel in the combustor for generating hot combustion gases from which energy is extracted in the high pressure turbine which in turn powers the compressor through a corresponding drive shaft extending therebetween.

A low pressure turbine follows the high pressure turbine and extracts additional energy from the hot core exhaust flow for powering the fan through a corresponding drive shaft extending therebetween. Propulsion thrust is generated in the engine by corresponding portions of the pressurized fan air bypassing the core engine, and the pressurized core exhaust discharged from the core engine.

Turbofan engines are typically identified by their bypass ratios. The bypass ratio represents the mass flow of the pressurized fan air bypassing the core engine divided by the mass flow of the core gases discharged through the core engine. The larger the bypass ratio, the more propulsion thrust is generated by the pressurized fan air compared with the core discharge flow.

In contrast, the lower the bypass ratio, the greater is the portion of propulsion thrust generated from the core engine exhaust flow. The specific bypass ratio therefore affects the type of thrust reverser provided in the engine, and the aerodynamic efficiency of thrust reverse operation.

The typical turbofan aircraft engine includes a fan thrust reverser mounted at the aft end of the fan nacelle surrounding the core engine. The thrust reverser is operated during landing of the aircraft on a runway and redirects the normally aft propulsion thrust from the engine in the forward direction to assist in braking the aircraft and aerodynamically reducing its speed.

The typical thrust reverser includes reverser doors which are deployed to redirect the normally aft fan exhaust in a forward direction from the fan nacelle. Correspondingly, blocker doors are typically also used with the reverser for substantially blocking aft discharge of the fan exhaust from the fan nozzle.

However, the core engine is still operated at elevated power upon landing to power the thrust reverse braking of the aircraft, and therefore a substantial amount of core exhaust is discharged through the core nozzle.

Accordingly, the overall efficiency of fan thrust reverse operation is based on the combined effect of the forward thrust from the redirected fan exhaust, and the aft thrust from the core engine which correspondingly reduces efficiency.

For high bypass ratio turbofan engines, the fan flow represents a substantial portion of the overall engine thrust, and operation of the fan reverser enjoys increased performance and efficiency.

In contrast, for low bypass turbofan engines, the core exhaust represents a substantial portion of the propulsion thrust, with the fan reverser having a correspondingly lower net performance and efficiency in braking the landing aircraft.

Accordingly, it is desired to provide a turbofan engine having improved thrust reverse operation for aircraft landing.

### BRIEF SUMMARY OF THE INVENTION

A turbofan engine includes a fan driven by a core engine. A surrounding fan nacelle includes a thrust reverser and fan nozzle disposed aft therefrom. A core cowl surrounds the core engine and includes a core nozzle extending aft therefrom. A row of poppet valves extends through the core cowl between the core nozzle and fan nozzle for selectively spoiling thrust from the core nozzle when the reverser is deployed.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is a partly sectional axial view of an exemplary turbofan aircraft gas turbine engine mounted to an aircraft wing, and including a fan thrust reverser integrated in the fan nacelle thereof.

FIG. 2 is an enlarged, axial sectional view of the fan reverser illustrated in FIG. 1 shown in a deployed position.

FIG. 3 is an enlarged, axial sectional view of a portion of the core nozzle illustrated in FIG. 1 including a thrust spoiler integrated therein, shown in a stowed position.

FIG. 4 is an enlarged, axial sectional view, like FIG. 3, illustrating the thrust spoiler in a deployed position.

FIG. 5 is an isometric view in isolation of an exemplary poppet valve used in the spoiler shown in FIGS. 3 and 4.

FIG. 6 is an isometric view of a poppet valve in accordance with another embodiment.

### DETAILED DESCRIPTION OF THE INVENTION

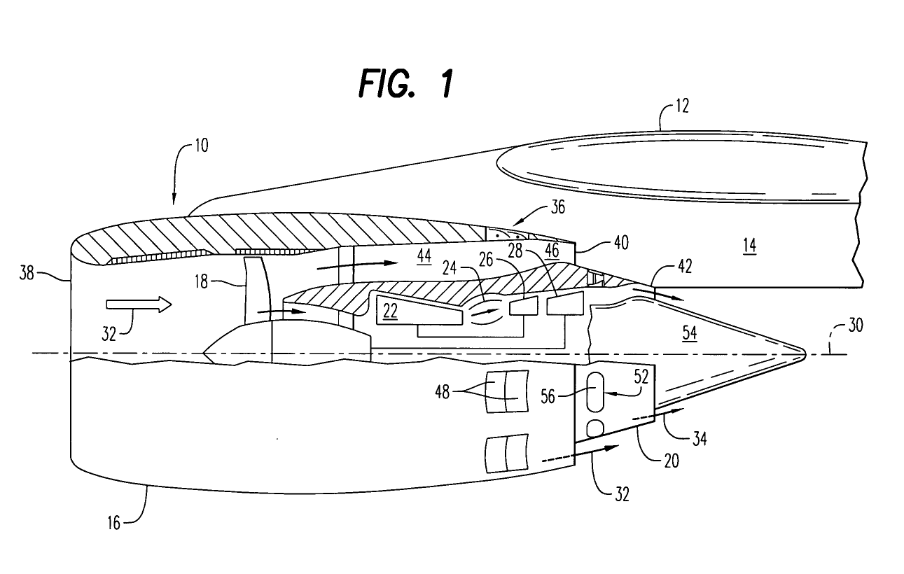

Illustrated in FIG. 1 is a turbofan aircraft gas turbine engine 10 suitably mounted to the wing 12 of an aircraft by a supporting pylon 14. Alternatively, the engine could be mounted to the fuselage of the aircraft if desired.

The engine includes an annular fan nacelle 16 surrounding a fan 18 which is powered by a core engine surrounded by a core nacelle or cowl 20. The core engine includes in serial flow communication a multistage axial compressor 22, an annular combustor 24, a high pressure turbine 26, and a low pressure turbine 28 which are axisymmetrical about a longitudinal or axial centerline axis 30.

During operation, ambient air 32 enters the fan nacelle and flows past the fan blades into the compressor 22 for pressurization. The compressed air is mixed with fuel in the combustor 24 for generating hot combustion gases 34 which are discharged through the high and low pressure turbine 26,28 in turn. The turbines extract energy from the combustion gases and power the compressor 22 and fan 18, respectively.

A majority of the air is pressurized by the driven fan 18 for producing a substantial portion of the propulsion thrust powering the aircraft in flight. The combustion gases 34 are exhausted from the aft outlet of the core engine for providing additional thrust.

However, during landing operation of the aircraft, thrust reversal is desired for aerodynamically slowing or braking the speed of the aircraft as it decelerates along a runway. Accordingly, the turbofan engine 10 includes a fan thrust reverser 36 wholly contained in or integrated into the fan nacelle 16 for selectively reversing fan thrust during aircraft landing.

The fan thrust reverser, or simply fan reverser 36 is integrated directly into the fan nacelle 16. The fan nacelle includes radially outer and inner cowlings or skins which extend axially from a leading edge of the nacelle defining an annular inlet 38 to an opposite trailing edge defining a substantially annular outlet 40. The fan nacelle 16 may have any conventional configuration, and is typically formed in two generally C-shaped halves which are pivotally joined to the supporting pylon 14 for being opened during maintenance operations.

The exemplary fan nacelle illustrated in FIG. 1 is a short nacelle terminating near the aft end of the core engine for discharging the pressurized fan airflow separately from and surrounding the hot exhaust gas flow 34 discharged from the aft outlet of a core nozzle 42. This exemplary turbofan engine is configured for low bypass operation.

The engine has a bypass ratio that represents the ratio of mass flow of the fan exhaust bypassing the core engine through the fan nozzle and the mass flow of the core exhaust discharged through the core nozzle. For a low bypass ratio less than about 5, the core thrust represents a substantial portion of the overall propulsion thrust, which also includes the fan thrust.

In the exemplary embodiment illustrated in FIG. 1, the core engine is mounted concentrically inside the fan nacelle 16 by a row of supporting struts in a conventional manner. The core cowl 20 is spaced radially inwardly from the inner skin of the fan nacelle to define an annular bypass duct 44 therebetween which bypasses a major portion of the fan air around the core engine during operation. The fan bypass duct terminates in a substantially annular fan nozzle 46 at the nacelle trailing edge or outlet 40.

A particular advantage of the fan reverser 36 is that the fan nozzle 46 itself may remain fixed at the aft end of the fan nacelle surrounding the core engine. And, the fan reverser 36 may be fully integrated in the fan nacelle immediately forward or upstream from the fixed fan nozzle.

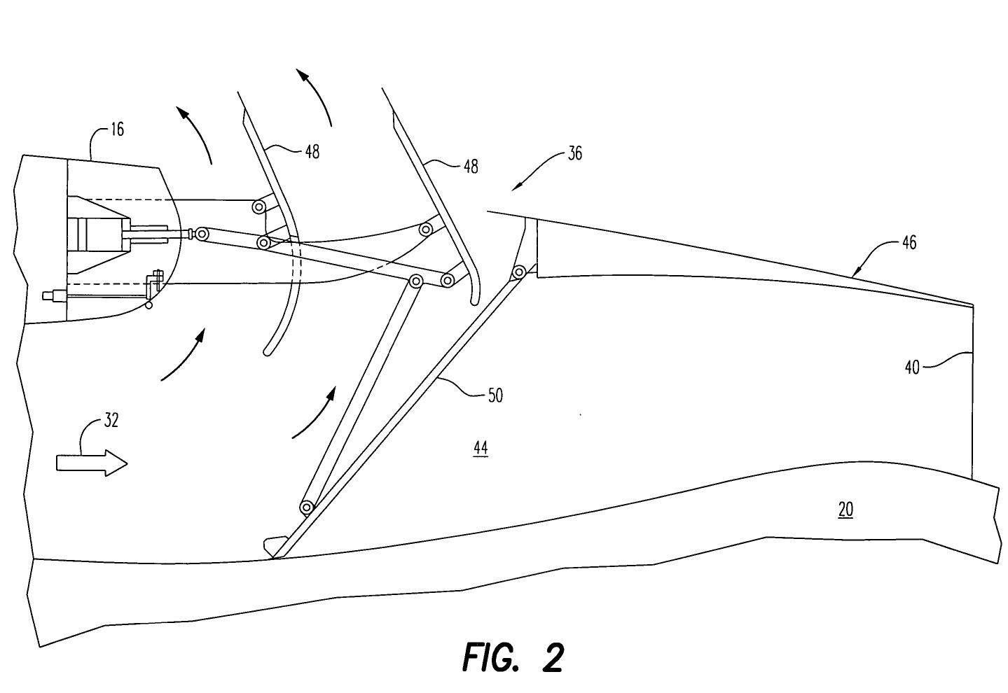

More specifically, the fan reverser is illustrated in more detail in FIG. 2 wherein the outer and inner skins of the fan nacelle are spaced radially apart to define an arcuate compartment or annulus spaced axially forwardly from the nacelle trailing edge 40. The nacelle compartment includes a flow tunnel or aperture extending radially between the inner and outer skins through which the pressurized fan bypass air 32 may be discharged during thrust reverse operation.

A gang or set of radially outer louver doors 48 are suitably pivotally joined to the fan nacelle in the compartment to close the exit end of the tunnel along the outer skin. Two or more of the louver doors may be axially nested together as further described hereinbelow.

A corresponding radially inner reverser or blocker door 50 is suitably pivotally joined to the fan nacelle 16 inside the compartment in radial opposition with the gang of louver doors 48 to close the inlet end of the tunnel along the inner skin. In the stowed closed position illustrated in FIG. 1, the inner door 50 is folded closed generally parallel with the corresponding gang of outer doors 48, converging slightly to conform with the converging profile or cross section of the nacelle.

Means in the form of an elongate drive link pivotally joins together the outer and inner doors for coordinating the simultaneous deployment thereof. Means in the form of a linear drive actuator are suitably mounted in the nacelle compartment and joined to the doors for selective rotation thereof from the stowed position illustrated in FIG. 1 at which the doors are pivoted closed substantially flush in the outer and inner skins respectively.

The actuator may be operated in reverse for rotating the doors to a deployed position illustrated in FIG. 2 at which the outer doors 48 are pivoted open and extend radially outwardly in part from the outer skin, with the inner door 50 being pivoted open and extending radially inwardly in most part from the inner skin. The outer and inner doors are interconnected by the drive link in an accordion or bifold manner in which the doors collapse or fold together in the stowed position illustrated in FIG. 1, and swing open with opposite inclinations in the deployed position illustrated in FIG. 2.

The bifold configuration of the outer louver doors and inner blocker door pennits all the components of the fan reverser to be integrated and hidden within the axial extent of the radial compartment between the outer and inner skins. The louver and blocker doors, the drive link, and the drive actuator are fully contained within the compartment in the stowed position illustrated in FIG. 1 without any flow obstruction by these reverser components inside the inner skin of the nacelle.

The bifold door fan thrust reverser 36 disclosed above is merely one of many preferred embodiments, and is more fully disclosed in U.S. Pat. No. 6,895,742, incorporated herein by reference. Any other type of fan thrust reverser may also be used as desired.

Irrespective of the form of the specific fan reverser used in the exemplary turbofan engine illustrated in FIGS. 1 and 2, the low bypass configuration of the engine generates a substantial portion of the total propulsion thrust from the core nozzle 42 during operation of the engine from takeoff, climb, cruise, and descent toward landing.

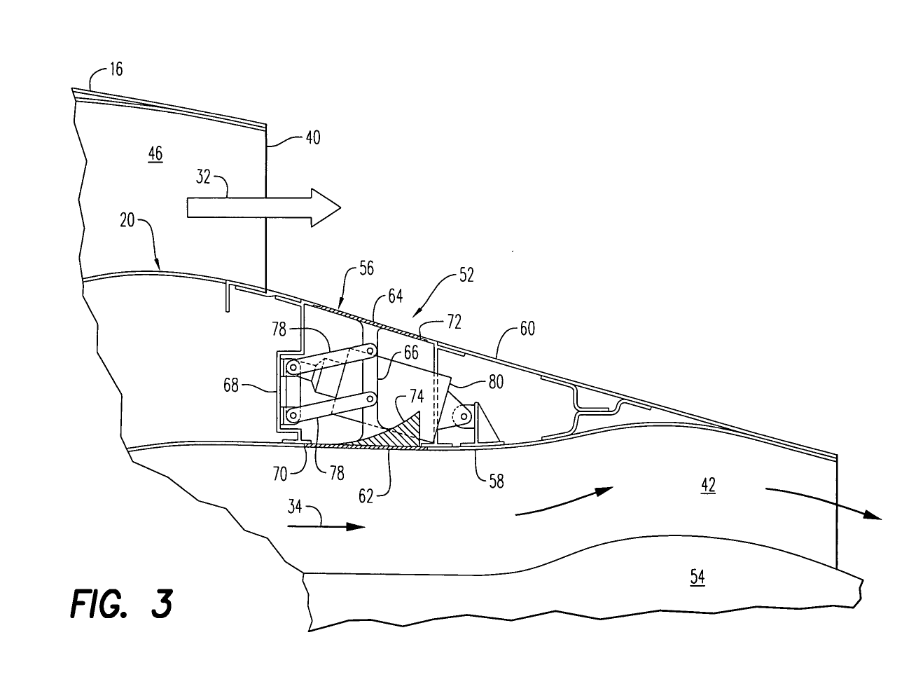

Accordingly, the low bypass turbofan engine illustrated in FIGS. 1 and 3 includes an assembly of components defining a thrust spoiler 52 which is operable solely during thrust reverse operation for spoiling or intentionally degrading aft propulsion thrust from the core engine. By spoiling core thrust, thrust reverse operation of the fan reverser, in any suitable configuration thereof, will have increased performance and efficiency overall in braking the speed of the landing aircraft.

The turbofan spoiler 52 includes in part the conventional fan nacelle 16 and any preferred form of the fan thrust reverser 36 terminating in the fan exhaust nozzle 46 disposed at the aft end of the fan nacelle. The cooperating core cowl 20 extends aft from the fan nozzle 46 and includes the core exhaust nozzle 42 at the aft end thereof. In the exemplary embodiment illustrated in FIGS. 1 and 2, the core nozzle 42 has a substantially annular configuration surrounded by the core cowl 20, and has an inner flowpath boundary defined by a conventional center plug 54.

Thrust spoiling is effected by a row of poppet valves 56 extending radially through the core cowl 20 between the core nozzle 42 and the fan nozzle 46 for selectively spoiling propulsion thrust from the core nozzle 42 solely when the fan reverser 36 is deployed.

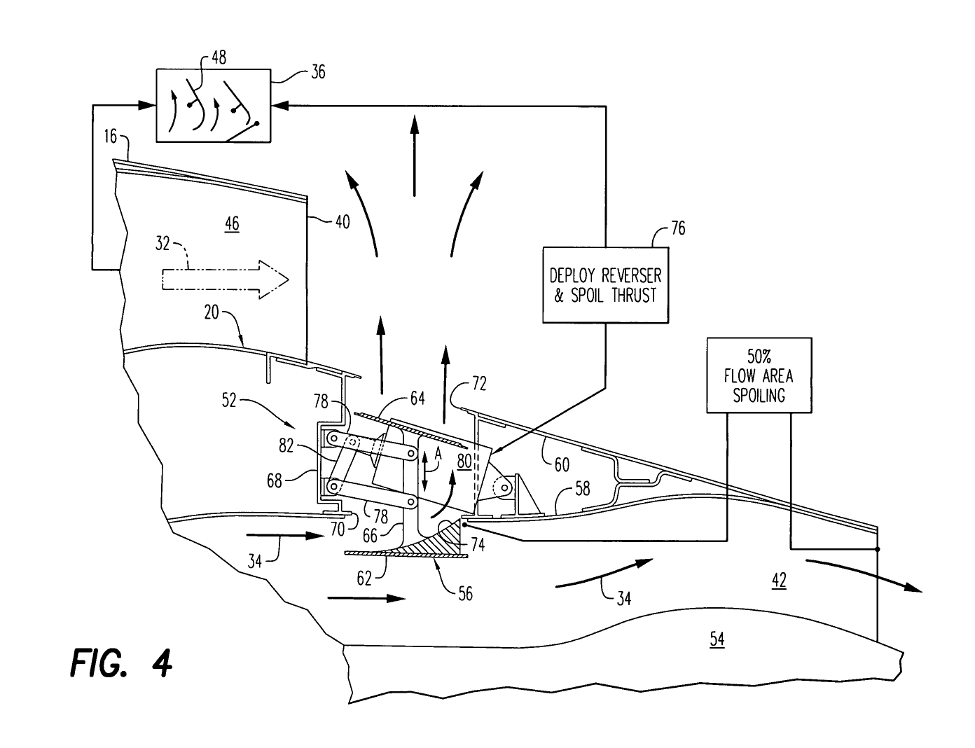

FIGS. 1 and 3 illustrate the poppet valves 56 stowed closed during normal aft propulsion operation of the engine, with the fan thrust reverser being correspondingly stowed closed. FIG. 4 illustrates thrust reverse operation of the engine with both the fan reverser 36 and poppet valves 56 being deployed open.

As shown in FIGS. 3 and 4, the core cowl 20 includes radially inner and outer skins 58,60 typically formed of sheet metal. The inner skin 58 surrounds the center plug 54 and defines an annular core exhaust duct which terminates in the core exhaust nozzle 42. The radially outer skin 60 extends aft from the fan nozzle 46 and defines the radially inner boundary of the fan bypass duct 44 terminating in the fan nozzle 46 illustrated in FIGS. 1 and 3.

A suitable number of the poppet valves 56 are spaced apart circumferentially around the perimeter of the core cowl 20 as illustrated in FIG. 1 for providing sufficient discharge flow area for effectively spoiling the aft core exhaust thrust when deployed.

The valves 56 preferably have identical configurations as illustrated in an exemplary embodiment in FIGS. 3-5. Each of the poppet valves 56 includes radially inner and outer heads 62,64 integrally joined together to opposite radial ends of a radially extending common supporting stem 66. Each valve 56 may be formed in a common and unitary casting, or may be an assembly of components rigidly interconnected by brazing or welding for example.

As shown in FIG. 3, the inner head 62 conforms with the annular profile of the inner skin 58 and is preferably disposed flush therein when stowed. Correspondingly, the outer head 64 conforms with the annular profile of the outer skin 60 and is preferably disposed flush therein when stowed.

The core cowl 20 further includes a rigid frame 68 defining a housing or box disposed between the inner and outer skins 58,60 and integrally joined thereto. The valve stems 66 are suitably mounted to the frame 68 for preferably radial translation A between the inner and outer skins for simultaneous and parallel movement of the valve heads when deployed.

As best illustrated in FIG. 4, the inner skin 58 includes a row of inner apertures 70 facing radially inwardly for sealingly receiving respective inner heads 62 of the valves when stowed. Correspondingly, the outer skin 60 includes a row of outer apertures 72 facing radially outwardly for sealingly receiving respective outer heads 64 of the valves when stowed.

The outer apertures 72 are preferably radially aligned directly outwardly from corresponding ones of the inner apertures 70 to provide an oblique or radially outward bleed path through the core cowl disposed substantially normal or 90 degrees from the axial centerline axis of the engine.

The poppet valves 56 are preferentially contained inside the core cowl 20 for maintaining the aerodynamic performance and efficiency of the turbofan engine throughout its operating flight envelope, with the poppet valves being deployed only during thrust reverse operation.

In the preferred embodiment illustrated in FIGS. 3 and 4, the core cowl 20 converges aft from the fan nozzle 46 for maintaining aerodynamic performance of the engine. The outer apertures 72 are disposed immediately aft of the outlet 40 of the fan nozzle 46 in the relatively thick portion of the core cowl between the radially spaced apart inner and outer skins 58,60 where space permits.

The outer heads 64 of the poppet valves are preferably inclined aft to conform flush with the converging outer skin 60 when the valves are stowed closed.

Correspondingly, the inner heads 62 conform with the profile of the inner skin 58 and are generally parallel with the axial centerline axis. Since the valves are deployed inwardly during operation, each of the inner heads 62 preferably includes a scoop or ramp 74 on the radially outer surface thereof which curves radially outwardly aft toward the core nozzle 42. The ramp 74 may be formed of suitable sheet metal rigidly mounted to the outer surface of the inner head 62.

Since the poppet valves are stowed closed during the entirety of operation of the turbofan engine except during thrust reverse operation, suitable means are provided for translating or moving each of the valves 56 radially inwardly to their deployed positions and radially outwardly to their stowed positions.

The translating means suitably mount each of the poppet valves 56 to the supporting frame 68 to selectively stow closed the inner heads 62 flush in the inner apertures 70, while the corresponding outer heads 64 are stowed closed flush in the outer apertures 72 as illustrated in FIG. 3. When stowed closed in FIG. 3, the heads 62,64 maintain an aerodynamically smooth profile with the corresponding inner and outer skins of the core cowl for maintaining aerodynamic efficiency of the turbofan engine.

However, during thrust reverse operation the individual poppet valves 56 are deployed open, with the corresponding inner heads 62 being translated radially inwardly below the inner skin 58 into the core exhaust duct, with the outer heads 64 being translated radially inwardly below the outer skin 60 while also being recessed between the two skins defining the core cowl.

FIG. 1 illustrates normal flight operation of the turbofan engine 10 in which aft propulsion thrust is generated from the air pressurized by the fan 18 discharged through fan nozzle 46, with additional aft propulsion thrust being generated by the core exhaust 32 pressurized by the core engine and discharged aft through the core nozzle 42. Both the core exhaust and the fan exhaust are discharged from their respective nozzles 42,46 smoothly and efficiently as intended when the poppet valves are stowed closed as illustrated in FIG. 3.

However, during thrust reverse operation as illustrated in FIGS. 2 and 4, the fan thrust reverser 36 is suitably deployed to block air flow through fan nozzle 46, with the pressurized fan exhaust instead being diverted in the forward direction for providing braking thrust from the engine as the aircraft decelerates along the runway.

Correspondingly, the row of poppet valves 56 are deployed open during thrust reverse operation to bleed or divert the hot exhaust flow from the core nozzle 42 and therefore substantially spoil or reduce the aft propulsion capability of the core exhaust flow. FIG. 4 illustrates schematically the engine controller 76 which is operatively joined to both the fan reverser 36 and the poppet valves 56 to coordinate their deployment during thrust reverse operation.

During that operation, the normally aft directed fan exhaust 32 is blocked by the reverser blocker doors 50 and redirected forwardly by the louver doors 48. The fan exhaust is therefore blocked from normal aft discharge through the fan nozzle 46 and the outlet 40 thereof shown in FIG. 4.

The deployed open poppet valves 56 provide a direct bypass from the core nozzle 42 radially outwardly through the core cowl 20 in the immediate vicinity directly aft of the fan nozzle outlet 40. Accordingly, the open poppet valves provide substantial pressure relief inside the core nozzle which substantially reduces or degrades the operating pressure of the core exhaust 34 to correspondingly substantially reduce the aft propulsion force therefrom in the core nozzle 42. The pressure of the core exhaust is substantially reduced, along with the aft velocity of the core exhaust which both reduce the aft propulsion capability thereof.

And, by diverting or bleeding a significant portion of the core exhaust 34 from the core nozzle 42 and radially outwardly through the core cowl, the flowrate of the core exhaust discharged through the core nozzle 42 is also reduced for further reducing the aft propulsion capability thereof.

Furthermore, the core exhaust 34 is preferably bled obliquely or substantially normal to the initially axially aft flow direction through the core nozzle radially outwardly immediately behind the fan nozzle outlet 40. The flow direction of the bled core exhaust therefore changes from axially aft to radially outwardly with little if any axially aft component when discharged radially outwardly through the outer apertures 72.

The relatively simple poppet valves 56 therefore are effective for substantially spoiling or degrading the normally aft propulsion thrust from the core exhaust 34 during thrust reverse operation for substantially increasing the overall thrust performance capability and efficiency of the thrust reverse operation of the entire turbofan engine.

During thrust reverse operation, the pressurized fan flow is blocked from reaching the outlet 40 of the fan nozzle as illustrated in FIG. 4. The hot pressurized core exhaust 34 may be efficiently bled from the core nozzle by selectively deploying open the row of poppet valves 56 which divert a significant portion of the core exhaust outwardly through the core cowl at the discharge end of the fan nozzle, and immediately adjacent thereto being closer to the fan nozzle 46 than to the downstream core nozzle 42.

The core exhaust is therefore spoiled in large part which correspondingly reduces the aft propulsion capability thereof which would otherwise be in opposition to the forward directed propulsion thrust from the fan exhaust discharged through the deployed fan reverser.

The means for deploying and translating the row of poppet valves 56 illustrated in FIGS. 3-5 may have various suitable configurations for the limited space provided within the converging core cowl. For example, the translating means may be in the preferred form of a 4-bar linkage combination of the valve stem 66 and supporting frame 68 for deploying and stowing the inner and outer heads 62,64 simultaneously in parallel movement radially inwardly and outwardly.

In particular, the 4-bar linkage includes a pair of parallel links 78 pivotally joined at opposite ends to a common stem 66 and the frame 68. The links 78 are preferably mounted at their forward ends to the frame 68 and extend downstream in the aft direction to join the stem 66.

In this way, the two links 78 pivot in parallel with each other from the upstream frame 68 to cause the common stem 66 to translate radially inwardly and outwardly in the typical 4-bar kinematic motion thereof. Since the stem 66 is mounted to the aft end of the two links 78, the aerodynamic forces acting on the poppet valves 56 when deployed will be carried under tension through the two links, and this can improve dynamic stability of the deployed valves.

Each poppet valve 56 may be deployed by using a suitable linear actuator 80 as shown in FIGS. 3-5 operatively joined to the links 78 by a rotary crank 82 for selectively rotating the links on the frame to translate the stems 66 radially inwardly and outwardly. The linear output rod of the actuator 80 will rotate the crank 82 when deployed, with the crank 82 providing a suitable torque for rotating one of the links 78 which in turn rotates the cooperating link 78 through the interconnected common stem 66.

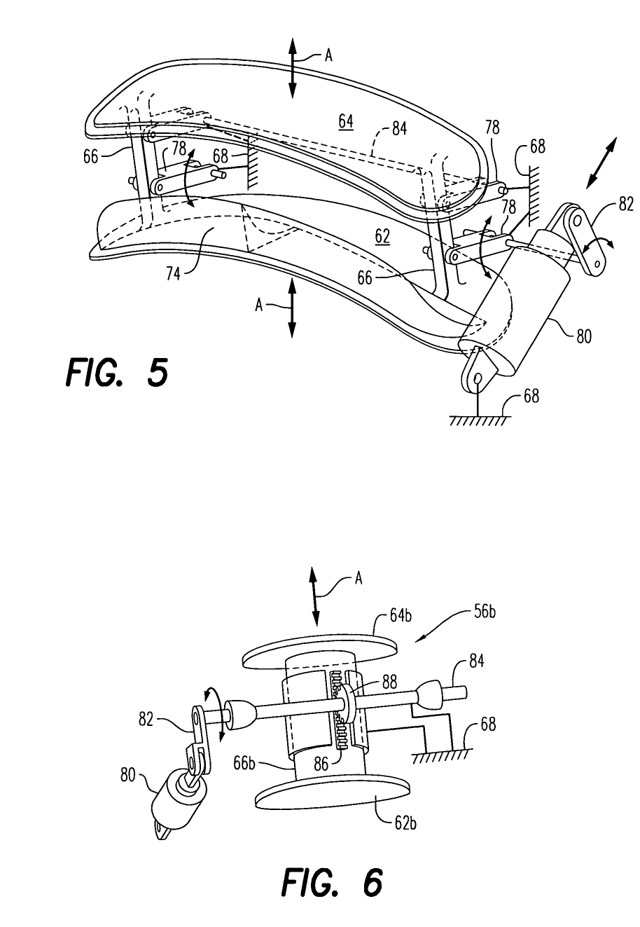

In the exemplary embodiment illustrated in FIG. 5, each of the poppet valves 56 includes a pair of the stems 66 spaced circumferentially apart from each other, and a pair of the links 78 are joined to each of the two stems 66. A connecting rod 84 fixedly joins together the proximal pivoting ends of two of the links 78 on corresponding stems to provide another mechanism for transferring torque from the crank 82 to both sets of 4-bar linkages.

In this embodiment, the inner and outer heads 62,64 are circumferentially elongate, with an oval or oblong configuration circumferentially around the core cowl 20. In this way, increased bleed area may be obtained around the circumference of the core cowl within a limited axial extent of the confined region of the core cowl.

In a preferred embodiment, the outer head 64 has a larger surface area facing radially inwardly toward the core exhaust duct than each of the inner heads 62 which may be used to advantage to bias closed the poppet valves due to the differential pressure between the core exhaust 34 inside the core nozzle 42 and the external lower pressure outside the core cowl 20.

Also in a preferred embodiment, the inner apertures 70 which are closed by the inner heads 62 preferably have a collective flow area around the inner skin 58 of the cowl corresponding with about half (50%) the discharge flow area of the core nozzle 42. In this way, a substantial reduction in pressure of the core exhaust 34 in the core nozzle may be achieved by opening the poppet valves 56 to correspondingly spoil the aft-directed thrust from the core nozzle.

In view of the limited space available within the converging core cowl illustrated in FIGS. 3 and 4, the simple poppet valves 56 provide a simple and effective mechanism for spoiling the core exhaust during thrust reverse operation. The poppet valves are also effective for redirecting the core exhaust radially outwardly and obliquely from the normally aft and axial direction thereof.

FIG. 6 illustrate an alternate embodiment of the poppet valves, designated 56b which like the original embodiment includes corresponding inner and outer heads 62b, 64b integrally joined to a common radial stem 66b. In this embodiment, the two heads 62b,64b are circular and fixedly joined to a single and central stem 66b.

The circular poppet valves 56b may also be disposed in the same axial location in the core cowl 20 as the original valves illustrated in FIGS. 3 and 4 in a similar row including a suitable plurality of the valves. The corresponding translating means may have any suitable configuration for translating radially inwardly and outwardly along the translation direction A the individual poppet valves 56b.

For example, a gear rack 86 and cooperating gear pinion 88 may be operatively joined to the corresponding stems 66b in the typical rack-and-pinion configuration for radially lowering and raising the corresponding poppet valves 56b.

For example, the rack 86 may be fixedly attached to the stem 66b along the radial axis. The pinion 88 may be pivotally mounted on a corresponding supporting or connecting rod 84 in operative engagement with the rack 86. A suitable linear actuator 80 may be similarly joined by a cooperating crank 82 to the connecting rod 84 and in turn the pinion 88 for selective rotation thereof, which in turn translates the rack 86 radially inwardly and outwardly along with the attached stem 66b.

In the various embodiments disclosed above, the introduction of a relatively simple poppet valve between the fan and core nozzles permits effective spoiling of propulsion thrust from the core nozzle when the fan thrust reverser is deployed. The overall performance and efficiency of thrust reverse operation is therefore increased. The poppet valve enjoys simplicity of configuration and may be introduced in various configurations where space permits, and fully contained and integrated between the skins of the core cowl. When the poppet valves are stowed, the cowl maintains its originally smooth surface finish for maintaining high aerodynamic performance of the turbofan engine for the entirety of the flight envelope as intended.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims in which I claim:

1. A turbofan spoiler comprising:
a fan nacelle including a thrust reverser and a fan nozzle disposed aft therefrom;
a core cowl extending aft from said fan nozzle and including a core nozzle at an aft end thereof, and
a row of poppet valves extending radially through said core cowl between said core nozzle and said fan nozzle for selectively spoiling thrust from said core nozzle when said reverser is deployed.

2. A spoiler according to claim 1 wherein:
said core cowl includes an inner skin defining a core exhaust duct terminating at said core nozzle, and a radially outer skin extending aft from said fan nozzle; and
each of said poppet valves includes inner and outer heads integrally joined to opposite ends of a radial stem, and said inner head is disposed in said inner skin, and said outer head is disposed in said outer skin.

3. A spoiler according to claim 2 wherein said core cowl further includes a frame disposed between said inner and outer skins, and said stems 66 are mounted to said frame for radial translation between said skins.

4. A spoiler according to claim 3 wherein:
said inner skin includes a row of inner apertures facing radially inwardly for receiving respective inner heads; and
said outer skin includes a row of outer apertures facing radially outwardly from said inner apertures for receiving respective outer heads.

5. A spoiler according to claim 4 wherein said core cowl converges aft from said fan nozzle, and said outer apertures are disposed aft of said fan nozzle.

6. A spoiler according to claim 4 wherein said outer heads are inclined aft to conform with said outer skin.

7. A spoiler according to claim 4 wherein said inner heads each includes a ramp curving radially outward toward said core nozzle.

8. A spoiler according to claim 4 further comprising means for translating said poppet valves to selectively stow closed said inner heads in said inner apertures and said outer heads in said outer apertures, and deploy open said inner heads radially inwardly below said inner skin and said outer heads radially inwardly below said outer skin.

9. A spoiler according to claim 8 wherein said translating means comprise a 4-bar linkage combination of said stems and said frame for deploying and stowing said inner and outer heads in parallel.

10. A spoiler according to claim 9 wherein said linkage includes a pair of parallel links pivotally joining each of said stems to said frame.

11. A spoiler according to claim 10 wherein said translating means further comprise an actuator joined to said links by a crank for selectively rotating said links on said frame to translate said stems radially inwardly and outwardly.

12. A spoiler according to claim 11 wherein:
each of said valves includes a pair of said stems spaced circumferentially apart, and a pair of said links joined to each of said stems 66; and
said translating means further comprise a connecting rod fixedly joining together opposite links on corresponding stems.

13. A spoiler according to claim 8 wherein said translating means comprise a rack and pinion operatively joined to said stems for radially lowering and raising said poppet valves.

14. A spoiler according to claim 13 wherein:
said stem includes said rack fixedly attached thereto;
said pinion is pivotally mounted in engagement with said rack; and
said translating means further comprise an actuator joined to said pinion for selective rotation thereof.

15. A spoiler according to claim 14 wherein each of said poppet valves includes a single stem.

16. A spoiler according to claim 8 wherein inner and outer heads are oval circumferentially around said core cowl.

17. A spoiler according to claim 8 wherein said inner and outer heads 62b,64b are circular.

18. A spoiler according to claim 8 wherein said outer heads have a larger surface area facing inwardly toward said core exhaust duct than said inner heads.

19. A spoiler according to claim 18 wherein said inner apertures have a collective flow area around said inner skin corresponding with about half the discharge flow area of said core nozzle.

20. A spoiler according to claim 8 further comprising:
a turbofan disposed inside a forward end of said fan nacelle for pressurizing air for discharge through said fan nozzle; and
a core engine disposed inside a forward end of said core cowl for generating core exhaust gases for discharge through said core nozzle.

21. A method of using said spoiler according to claim 1 comprising:
deploying said thrust reverser to block air flow through said fan nozzle 46; and
deploying said poppet valves to bleed exhaust flow from said core nozzle.

22. A method according to claim 21 further comprising bleeding said exhaust flow radially outwardly through said core cowl at the discharge end of said fan nozzle.

23. A method of spoiling thrust in a turbofan engine comprising:
operating said engine to generate thrust from air pressurized by a fan 18 in a fan nacelle, and from core exhaust pressurized by a core engine in a core cowl extending aft from said fan nacelle;
deploying a thrust reverser in said fan nacelle to block discharge of said pressurized air from a fan nozzle at an aft end of said fan nacelle; and
bleeding said pressurized core exhaust obliquely through said core cowl to spoil aft thrust from said turbofan engine.

24. A method according to claim 23 wherein:
said core exhaust flows axially aft inside said core cowl from said core engine to a core exhaust nozzle at an aft end thereof; and
said core exhaust is bled radially outwardly through said core cowl closer to said fan nozzle than to said core nozzle to spoil thrust from said turbofan engine.

25. A method according to claim 24 wherein said core exhaust is bled by selectively deploying a row of poppet valves mounted radially through said core cowl.
